(19) United States
(12) Patent Application Publication
(10) Pub. No.: US 2009/0073973 A1
(43) Pub. Date: Mar. 19, 2009

(54) Router having black box function and network system including the same

(76) Inventors: Bup-joong Kim, Daejeon-si (KR); Hak-suh Kim, Daejeon-si (KR); Byung-jun Ahn, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/156,333

(22) Filed: May 29, 2008

(30) Foreign Application Priority Data
Sep. 13, 2007 (KR) 10-2007-0093189

(51) Int. Cl. H04L 12/56

(52) U.S. Cl. 370/389; 370/216; 370/392

(57) ABSTRACT

A router having a black box function capable of storing a data block of a specific node or node group in a network, and a network system including the router are provided. The router includes: a black box memory storing node data; at least one packet preprocessor selecting and processing a data packet required to be stored in a black box from node data transferred via a wired/wireless transmission medium; a data storage storing the node data transferred through the packet preprocessor in the black box memory; a data reader reading corresponding node data in response to a node data transfer request from an external device; and a data transmitter processing the node data read by the data reader in the form of a packet and transferring the packet to the external device.

### CROSS REFERENCE TO RELATED APPLICATIONS

This application claims priority from Korean Patent Application No. 10-2007-0093189, filed on Sep. 13, 2007, the disclosure of which is incorporated herein in its entirety by reference.

### BACKGROUND OF THE INVENTION

1. Field of the Invention

The present invention relates to a network device, and more particularly, to a router having a black box function capable of storing a data block of a specific node or node group in a network, and a network system including the router.

This work was supported by the IT R&D program of Ministry of Information and Communication (MIC)/Institute for Information Technology Advancement (IITA) [2006-S-061-02, R&D on router technology for IPv6-based QoS services and host mobility].

### DESCRIPTION OF THE RELATED ART

Proliferation of the Internet and Internet Protocol (IP) has led to the present situation in which not only personal computers (PCs) but various electronic devices are capable of connecting to the Internet, and there is increasing demand for the ability to collect information using the Internet in conjunction with remotely controllable small embedded devices, sensors and so on. Due to recent developments in wireless technology, environments supporting the provision of Internet service are being constructed in places where such construction was previously not possible. However, the Internet is based on wired technology and thus cannot sufficiently satisfy characteristics and requirements of recently produced, small-scale, low-power devices such as wireless sensor nodes.

Examples of such devices are sensor nodes distributed in regions where the natural environment is very dangerous, data collection devices for short-lasting dangerous situations such as typhoons or hurricanes, data collection devices for monitoring and collecting data in regions that are dangerous due to a military threat or similar reasons. A sensor node or data collection node may be destroyed or rendered unable to function at any time, and thus information collected from the node may be lost. In such a case, retransfer of the lost data is almost impossible due to insufficient processing power, insufficient resources, unstable power supply, etc., of a small-scale node. Even if the lost data could be retransferred, the retransfer would not be reliable because the node could malfunction at any time when located in a dangerous region.

A node gateway relaying Internet access may be used instead of one or several nodes. However, danger around a node affects the gateway as well as the node, and thus the node gateway cannot be a fundamental solution.

Meanwhile, the increasing diversity of nodes accessing the Internet requires changes in Internet equipment and environments. Since a final message may be lost due to Internet congestion or instability as mentioned above, an input router physically and logically adjacent to the node needs to temporarily or permanently store data of the node. Due to the diversity of hosts accessing the Internet, real-time relay, reliable transfer, a high band, etc., are required, and it is also required that data be transferred to its destination regardless of a little delay.

Developments in semiconductor technology have led to the development of various recording media, remarkable increase in the capacity of the recording media, and improvement in processing power with respect to cost and power consumption. Thus, an Internet router can have many functions in addition to a conventional routing function. It may have a function of processing and storing data of a small-scale node, such as a sensor node, and allowing a server to load the stored data when data is lost or the node is out of order. In general, a network of small-scale sensors is connected to the Internet through a gateway and an Internet input router, controlled by a remote server, and receives instructions to collect data. When a method and apparatus capable of preventing loss of sensor data in steps are applied to this environment, it is possible to prevent danger in each step from affecting a next step and to reliably transfer data.

Currently, the main functions of a router are to relay packets to their destinations, exchange and share route information between routers, prevent attacks of illegal or malicious packets, authenticate users and grant the right to use network resources, and so on. Thus far, a router has generally been thought of as a point through which data passes rather than stays at. In a dangerous environment, a node group constituting a small scale wireless network or a node operating by itself may transfer data that is almost impossible to retransfer to a server. In this case, it is possible to easily establish a reliable network and efficiently use network resources when a router positioned at the entrance of the Internet has a function of storing and transferring the data.

### SUMMARY OF THE INVENTION

The present invention provides a router having a black box function capable of supporting transfer of an aperiodic or final message of a specific node or node group that might be lost due to an unstable network to a final server or host without any accident, and a network system including the router.

The present invention further provides a router capable of selecting data required to be stored in a black box from node data and storing the selected data in the black box, and a network system including the router.

The present invention further provides a router capable of backing up important data, or an aperiodic or final message of a specific node or node group that might be lost due to an unstable network to a third place or multiple times to minimize loss of important data, and a network system including the router.

The present invention further provides a router having a black box function capable of selecting data satisfying a condition from data transferred from a specific node or node group and storing only the selected data.

Additional aspects of the invention will be set forth in the description which follows and, in part, will be apparent from the description, or may be learned by practice of the invention.

The present invention discloses a router having a black box function, including: a black box memory for storing node data; at least one line interface card for preprocessing and transferring a packet transferred via a wired/wireless transmission medium; and a main processing unit for selectively storing node data transferred from each line interface card in the black box memory, and reading and transferring data requested to be transferred by an external device.

The main processing unit may back up the node data stored in the black box memory to at least one designated router existing in the same network.

Only node data satisfying a configurable condition may be filtered and stored in the black box memory.

The present invention also discloses a router having a black box function, including: a black box memory for storing node data; at least one packet preprocessor for selecting and processing a data packet required to be stored in a black box from node data transferred via a wired/wireless transmission medium; a data storage for storing the node data transferred through the packet preprocessor in the black box memory; a data reader for reading corresponding node data in response to a node data transfer request from an external device; and a data transmitter for processing the node data read by the data reader in the form of a packet and transferring the packet to the external device.

The router may further include a data backup unit for backing up the node data stored in the black box memory to at least one designated router existing in the same network.

The router may further include a data filter for filtering only node data satisfying a configurable condition among the node data transferred through the packet preprocessor, and transferring the node data to the data storage.

The above-described different types of routers select and store node data required to be stored in a black box from the node data transferred from each node, and transfer the stored node data in response to a request of an external device such as a host. Thus, it is possible to transfer an aperiodic or final message of a specific node or node group that might be lost due to an unstable network to a final server or host without any accident.

The present invention also discloses a network system for relaying node data transferred from at least one node group via a wired/wireless transmission medium to a final destination device, including: a black box router for selecting a data packet required to be stored in a black box from the node data transferred via the transmission medium, storing the selected data packet in a black box memory, and reading and transferring data required by the final destination device among the stored data; and an output router for transferring the data relayed or provided through the black box router to the final destination device.

The present invention also discloses a network system for relaying node data transferred from at least one node group via a wired/wireless transmission medium to a final destination device, including: a node for transferring a packet having information of a header including a first destination address and a second destination address; a first router for transferring the packet to a device having the first destination address included in the header of the packet transferred from the node; and a black box router for storing node data of the packet transferred from the first router in a black box memory, and relaying a corresponding node data packet to a device having the second destination address.

Each of the network systems may further include at least one backup device for backing up the node data stored in the black box memory.

The above-described network systems also select and store node data required to be stored in a black box, and transfer the stored node data in response to a request of an external device such as a host. Thus, it is possible to transfer an aperiodic or final message of a specific node or node group that might be lost due to an unstable network to a final server or host without any accident.

It is to be understood that both the foregoing general description and the following detailed description are exemplary and explanatory and are to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows the construction of a network system including a router having a black box function according to an exemplary embodiment of the present invention.

FIG. 2 shows the structure of a data packet according to an exemplary embodiment of the present invention.

FIGS. 3A and 3B are block diagrams of a router according to exemplary embodiments of the present invention.

FIG. 4 illustrates a non-volatile circular buffer according to an exemplary embodiment of the present invention.

FIG. 5 is diagrams illustrating operations according to an exemplary embodiment of the present invention.

FIG. 6 shows the construction of a network system including a router having a black box function according to another exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is through, and will fully convey the scope of the invention to those skilled in the art. Like reference numerals in the drawings denote like elements.

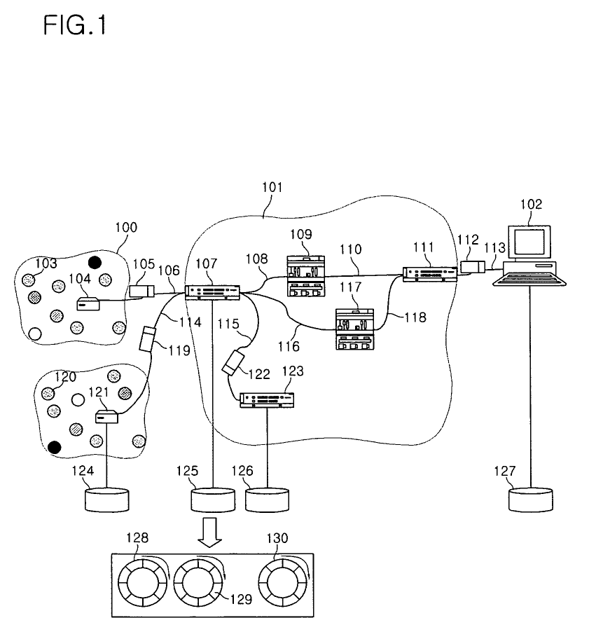

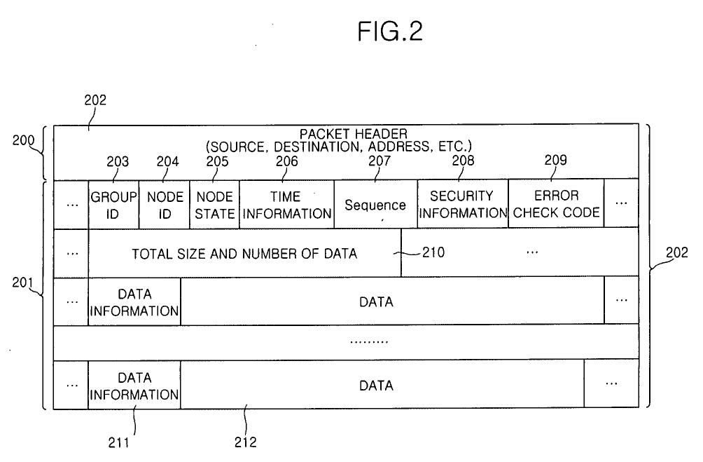

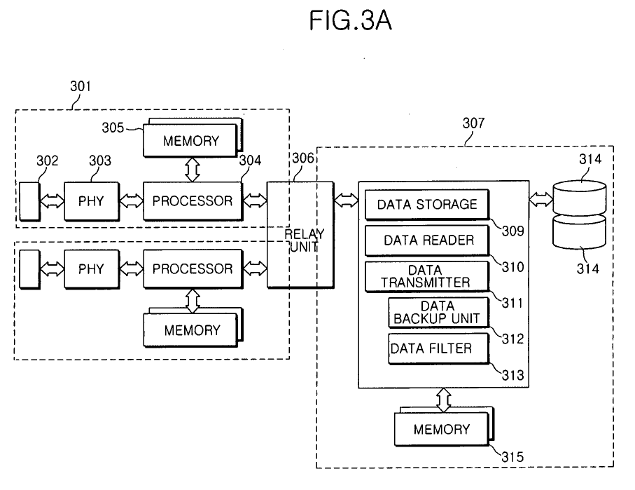

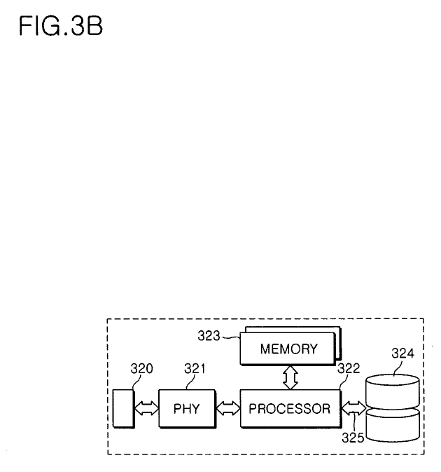

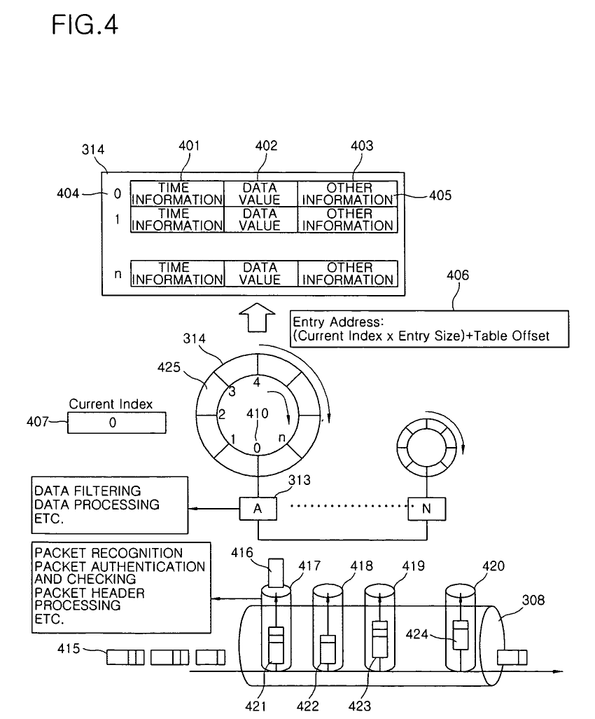

FIG. 1 shows the construction of a network system including a router 107 having a black box function according to an exemplary embodiment of the present invention. FIG. 2 shows the structure of data transferred by a node according to an exemplary embodiment of the present invention. FIGS. 3A and 3B are block diagrams of the router 107 according to exemplary embodiments of the present invention. FIG. 4 shows a non-volatile circular buffer as a black box memory according to an exemplary embodiment of the present invention.

Referring to FIG. 1, a node group 100 to which one or a plurality of nodes 103 and 120 belong transfers node data 105 and 119 to a host 102 that is a final destination, such as a server, etc., through node gateways 104 and 121 via a network 101, such as the Internet, etc. When the nodes 103 and 120 do not have enough processing power or resources, there is a limit in storing or buffering node data. Thus, a device 124 in which important data can be stored or buffered may be added to the external gateways 104 and 121.

The structure of node data according to an exemplary embodiment of the present invention will now be described with reference to FIG. 2. First, a node data packet 202 transferred from the nodes 103 and 120 may be roughly divided into a packet header 200 required for routing the packet in a network and a portion 201 containing information on node data itself. The packet header 200 contains address information required for routing the packet, thus allowing the packet to be relayed to the final destination in the network. The packet header 200 may consist of one header having only a first destination address, or a double header having a first destination address and a second destination address according to exemplary embodiments of the present invention.

Meanwhile, the node data portion 201 includes metadata on the node data. The metadata includes an identifier 203 of a group or small group to which a node belongs, an identifier 204 of the node itself, a node state 205, time information 206, a data sequence 207, security information 208, a data error check code 209, number and size information 210 on all of the data, and so on. Other node data is actual node data 212 and data information 211, and the data information 211 includes information on a type, size, etc., of the node data.

Referring again to FIG. 1, the gateways 104 and 121 transfer and receive a data packet of a node or node group to and from the input router 107 located at the entry of the network 101 through wired/wireless connection lines 106 and 114. The input router 107 is a router for a black box, i.e., a black box router, according to an exemplary embodiment of the present invention, and has a black box memory 125 to store recent node data of a main node. As illustrated in the drawing, the black box memory 125 can consist of a plurality of circular buffers 128, 129 and 130. In other words, the black box router 107 serves to transfer data to an output router 111 adjacent to the final data consuming stage 102 through the relay of core routers 109 and 117 positioned at the center of the network 101. In an exemplary embodiment of the present invention, the black box memory 125 is a non-volatile circular buffer. However, at least one of a non-volatile flash memory, a hard disk, a compact flash memory, a Secure Digital (SD) card memory, a volatile Synchronous Dynamic (SD) Random Access Memory (RAM), a Static RAM (SRAM), a Rambus Dynamic RAM (RDRAM) and a Reduced Latency DRAM (RLDRAM) may be used as the black box memory 125.

The construction of the black box router 107 will be described in further detail with reference to FIG. 3A. As illustrated in FIG. 3A, the medium- or large-sized black box router 107 according to an exemplary embodiment of the present invention may be roughly divided into at least one line interface card 301 and a main processing unit 307. The line interface card 301 preprocesses a packet transferred via a wired/wireless transmission medium. The main processing unit 307 selectively stores node data transferred from each line interface card 301 in a black box memory 314, and reads and transfers data requested to be transferred by an external device. The black box memory 314 for storing node data is connected with a main processor 308 in the main processing unit 307 directly or through a bridge. A relay unit 306 exists between the line interface card 301 and the main processing unit 307 so that node data transferred from the line interface card 301 can be relayed to the main processing unit 307.

More specifically, the line interface card 301 includes a line connection module 302, a block 303 for processing the physical layer of a packet, a processor 304 for packet separation, authentication, classification, scheduling, etc., and a memory 305 for storing information required for packet processing, and so on. The line interface card 301 recognizes that a packet is a data packet of a node required to be processed in a black box, passes the packet through an authentication process, a basic header management process and a processing process, and then transfers node data to the main processing unit 307 via the relay unit 306. In other words, the line interface card 301 preprocesses a packet transferred via a wired/wireless transmission medium and transfers the preprocessed packet to the main processing unit 307. Alternatively, the line interface card 301 selectively processes a data packet required to be stored in a black box among node data transferred via a wired/wireless transmission media, and transfers the processed data packet to the main processing unit 307. Thus, the line interface card 301 may be referred to as a packet preprocessing unit. In the former case, it is assumed that all node data is stored. The processor 304 of the line interface card 301 may filter and store only node data satisfying a configurable condition in the black box memory 314.

There is a method of recognizing whether a packet is a data packet of a node required to be processed in a black box. According to the method, when a user subscribes to a black box service, user information, i.e., a Media Access Control (MAC) address, an Internet Protocol (IP) address, a used protocol, and an entire or partial port address, is transferred to the service provider. Based on the user information, it is possible to distinguish a packet according to the methods below.

There is a method of classifying a packet filtered based on five properties, i.e., source and destination IP addresses, source and destination ports, and protocol, as a service-providing packet, and then finally authenticating the packet as a service-providing packet through additional authentication and cryptanalysis processes. According to another method, a protocol number, i.e., a private protocol, supporting a black box function may be obtained from an IP header and recognized, and then additional authentication and cryptanalysis processes may be performed using a user header to distinguish the corresponding packet.

Meanwhile, the main processing unit 307 selectively storing node data transferred from the line interface card 301 in the black box memory 314 basically includes a data storage 309, a data reader 310 and a data transmitter 311. The data storage 309 stores node data transferred through the line interface card, i.e., packet preprocessor, 301 in the black box memory 314. The data reader 310 reads recent or final data of the corresponding node in response to a node data transfer request from an external device such as a host and a server. The data transmitter 311 processes the node data read by the data reader 310 in the form of a packet and transfers the packet to the external device. Additionally, the black box router 107 may include a data backup unit 312 and a data filter 313. The data backup unit 312 backs up node data stored in the memory 314 to at least one backup device, e.g., a backup router 123, existing in the same network 101. The data filter 313 filters only node data satisfying the configurable condition among node data transferred through the line interface card, i.e., a packet preprocessor, 301 and transfers the filtered node data to the data storage 309.

To filter desired data, a conditional statement may be set by selecting a condition or inputting a conditional value on a previously input menu, i.e., a Graphic User Interface (GUI) or a Command Line Interface (CLI). In addition, there is a method of accessing a router using a telnet and entering a conditional input command and a condition at a router command prompt. Furthermore, there is another method of transferring a control message through a data path of a router from a remote place to the router, and still another method of issuing instructions from a console of a router and loading a file through a management port.

Besides the above-described functions, the main processor 308 of the black box router 107 according to an exemplary embodiment of the present invention executes a basic application program of the router, performs routing table management, and so on. In addition, the main processor 308 may perform serial or parallel processes, such as packet recognition, packet authentication and checking, packet header processing, data filtering and data processing with respect to node data transferred from the line interface card 301, and store the processed node data in the black box memory 314, which can be implemented by a plurality of non-volatile circular buffers.

In the above descriptions, it is assumed that the router 107 has a medium or large size. On the other hand, when the router 107 has a small size as illustrated in FIG. 3B, one processor 322 performs a line interface function and a main processor function. In this case, node data is basically processed in a similar way to the above-described medium- or large-sized router. As illustrated in FIG. 3B, most small routers include a line connection module 320, a block 321 for processing the physical layer of a packet, and the processor 322. Therefore, when the processor 322 is connected with a black box memory 324 directly or through a bridge 325 and is programmed to perform the above-described basic functions of a packet preprocessor, a data storage, a data reader and a data transmitter, node data can be processed as in a medium or large-sized router. Needless to say, the processor 322 can be designed to perform the functions of a data backup unit and a data filter.

Thus far, the construction of the router 107 having a black box function has been described in detail. Referring back to FIG. 1, the core routers 109 and 117, the black box router 107 and the output router 111 have physical and logical connection lines 108, 116, 110 and 118 and thus can transfer a packet entering or exiting the network 101. The output router 111 transfers node data 112 through a physical or logical connection line 113 connected with the final destination host 102. The final destination host 102 has a device 127 for storing node data. A router in the network 101 is designated as the backup router 123, and a physical or logical connection line 115 is connected between the black box router 107 and the backup router 123 so that node data 122 stored in the black box router 107 can be backed up to a black box memory 126 of the backup router 123. This is for a case in which it is impossible to transfer node data due to loss of the node data stored in the black box router 107 or a fault of a transmission medium around the router 107.

FIG. 4 shows a non-volatile circular buffer constituting the black box memory 314 illustrated in FIG. 3A to describe in detail how a node data packet is stored in the black box memory 314.

When various packets 415 are input through the line interface card 301, the packets are processed in the physical layer and then passed through the main processor 308 performing serial or parallel processes. Here, the main processor 308 analyzes header information, etc., of the packets to recognize whether the packets are to be stored in the black box memory 314, whether the packets are data of an authenticated node or group, whether a partial header or data of the packets needs to be processed, and performs the corresponding action. The black box memory 314 consists of a plurality of non-volatile circular buffers (or volatile buffers as occasion demands). The packets can be classified and stored in the respective non-volatile circular buffers according to data types, node groups or small groups. Passages 417, 418, 419 and 420 to the several non-volatile circular buffers of a black box exist for the respective non-volatile circular buffers. In other words, the main processor 308 transfers packets 421, 422, 423 and 424 required to be processed in a black box through the non-volatile circular buffer passages 417, 418, 419 and 420 corresponding to node data types and groups. The packets passed through the non-volatile circular buffer passages 417, 418, 419 and 420 are passed through the data filter 313 in front of the non-volatile circular buffer 314 in the form of pure node data 416 except network header information, etc. Since the data filter 313 processes and stores node data in various forms, or filters redundant data, etc., it has a variable structure to turn on or off a part or all of the functions. The node data passed through the data filter 313 is stored in the non-volatile circular buffer 314. A storage position is found using a current position index 407 and then the node data is stored at a position 410 indicated by the current position index 407. An actual address value of the non-volatile circular buffer slot 425 may be an index itself or a result of a simple addressing operation 406. In result, time information 401, a data value 402, other information 403, etc., of a node are contained as the node data in an addressing space indicated by a non-volatile circular buffer index 404. The types, sizes, etc., of the stored data may vary according to node types and data types.

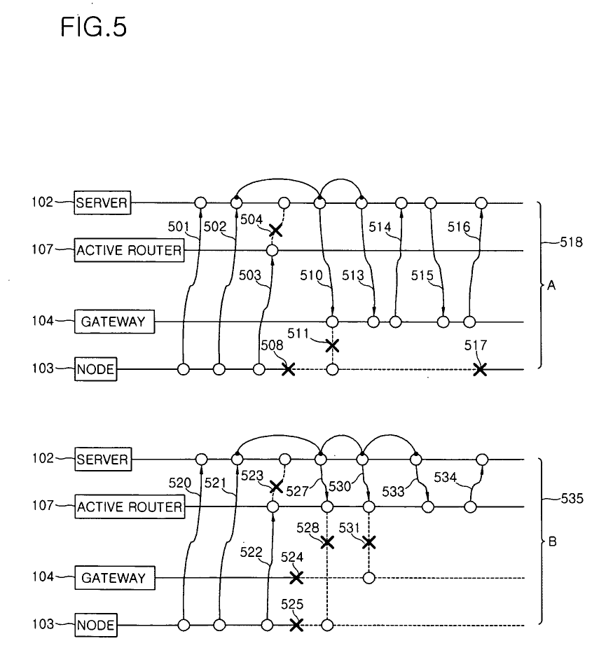

FIG. 5 is diagrams illustrating operations according to an exemplary embodiment of the present invention. More specifically, FIG. 5 shows a case in which node data is normally transferred to a server 102 that is a final destination by a router having a black box function when a final aperiodic packet of a node is lost due to an unstable network. The operation is based on the assumption that node data required to be processed in a black box is already stored in a non-volatile circular buffer of a black box router according to the method described with reference to FIG. 4.

Referring to A 518 of FIG. 5, a node 103 transfers node data 501 and 502 to the server 102 at specific time intervals, but node data 503 is lost 504 due to network instability or congestion. Subsequently, when the node 103 does not operate any more 508 due to malfunction, change in surroundings, etc., and the server 102 recognizes that node data is not received for a specific time period 509, the server 102 transfers a state query and a data retransmission request 510 to the node 103. Here, since the node 103 does not operate, the messages are transferred 510 to a gateway 104 of the node 103 but no further 511. When the server 102 checks 512 that there is no response from the node 103 and transfers 513 a message requesting to check final data of the node 103 to the gateway 104 of the node 103, the gateway 104 loads recent data of the node 103 from its non-volatile circular buffer and transfers 514 the data to the server 102. After this, the server 102 exchanges 515 and 516 messages for checking whether the node 103 is up with the gateway 104. When the node 103 is up again, it starts normal data transmission together with the server 102.

However, when either of the node 103 and the adjacent gateway 104 does not operate due to malfunction or change in surroundings, node data cannot be transferred to the server 102. This problem can be solved by a black box router according to an exemplary embodiment of the present invention.

Referring to B 535 of FIG. 5, the node 103 transfers node data 520 and 521 to the server 102 at specific time intervals, but node data 522 is lost 523 due to network instability or congestion. Subsequently, when the gateway 104 adjacent to the node 103 and the node 103 cease to operate 524 and 525 due to malfunction, change in surroundings, etc., and the server 102 recognizes that node data is not received for a specific time period 526, the server 102 transfers a state query and a data retransmission request 527 to the node 103. Here, since neither the node 103 nor the gateway 104 is operational, the messages are transferred 527 to a black box router 107 corresponding to an input router of the node 103 but no further 528. When the server 102 checks 529 that there is no response from the node 103 and transfers 530 a message requesting to check final data to the gateway 104 of the node 103, the message is not transferred 531 to the gateway 104 due to malfunction of the gateway 104. When the server 102 recognizes 532 that there is no response from the gateway 104, it requests 533 recent data of the node 103 from the black box router 107. In response to the request, the black box router 107 reads recent data of the node 103 stored in its non-volatile circular buffer 314 and transfer 534 the recent data to the server 102.

Therefore, the present invention solves the fundamental problem of the final aperiodic message of a node or node group collecting important data in a dangerous region being lost due to packet network instability.

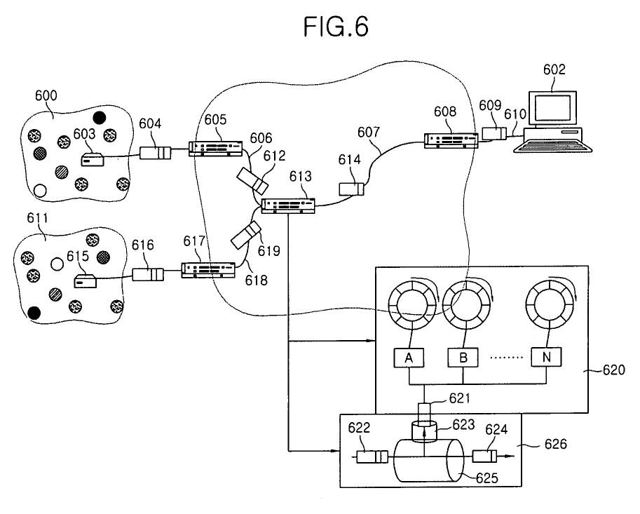

FIG. 6 shows the construction of a network system including a router having a black box function according to another exemplary embodiment of the present invention. The network system includes a node, a first router and a black box router. The node transfers a packet having header information including a first destination address and a second destination address. The first router transfers the packet to a device having the first destination address included in a header of the packet transferred from the node. The black box router stores node data of the packet transferred from the first router in a black box memory, and then relays the corresponding node data packet to a device having the second destination address. The construction will be described in further detail with reference to FIG. 6.

FIG. 6 shows that input routers 605 and 617 of nodes or node groups 600 and 611 may differ from a black box router 613 supporting a black box function. When nodes or node groups are physically and logically far away from each other or use different network systems or addressing systems, appropriate input routing services to the respective nodes or node groups are required, and thus data required to be processed in a black box can be input into a network 601 through several input routers. In this case, the input routers 605 and 617 connected with the node groups are different from each other. However, nodes or gateways 603 and 615 transfer packets 604 and 616, in which a double header having an address of the black box router 613 as a first destination address and an address of a final destination host 602 as a second destination address is attached to node data, to the input routers 605 and 617, and the input routers 605 and 617 transfer double header packets 612 and 619 to the black box router 613 designated in first headers of the double header packets 612 and 619 through physical or logical connection lines 606 and 618 so that the black box router 613 can process data of a plurality of node groups. After the black box router 613 determines that the packets 612 and 619 are required to be processed in a black box on the basis of their header information, it stores their node data 621 in a black box memory 620 and transfers node data packets 614 and 624 from which first header information is removed to the final destination. The black box router 613 has a main processor 626 for performing a series of processes as described above. The main processor 626 has a processing function 625 of separating, authenticating and processing a packet 622 having a double header structure, and a processing function 623 of searching for a packet required to be stored in a black box and extracting node data.

The black box router 613 transfers the node data 614 having a second destination header through a connection line 607 physically or logically connected to an output router 608, and the output router 608 transfers data 609 to the destination host 602 through a wired/wireless line 610 connected with the host 602.

The above-described network system also selects node data required to be stored in a black box, stores it in a black box router, and transfers it in response to a request from an external device such as a host, thereby transferring an aperiodic or final message of a specific node or node group that might be lost due to an unstable network to a final server or host without any accident.

The above-described exemplary embodiments of the present invention may be stored in any form of recording media, such as Compact Disk Read-Only Memory (CD-ROM), RAM, ROM, floppy disk, hard disk, or magneto-optical disk, or in any computer-readable form, such as computer code organized into executable programs. A description of a method of storing an exemplary embodiment of the present invention is well known in the art and will be omitted.

As apparent from the above description, a router according to an exemplary embodiment of the present invention has a black box memory that may comprise a non-volatile circular buffer, stores a final data block of a specific node or node group or a final data block satisfying a specific condition in the black box memory, and transfers the stored data to an external device requiring it.

The above-described different types of routers select and store node data required to be stored in a black box from node data transferred from respective nodes, and transfer the stored node data at the request of an external device such as a host. Thus, it is possible to transfer an aperiodic or final message of a specific node or node group that might be lost due to an unstable network to a final server or host without any accident. Consequently, the present invention can safely transfer data of each node to a server or host.

In addition, the present invention backs up data stored in a black box to an external device through multiple steps and thus can increase the reliability of a data transfer network system.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A router having a black box function, comprising:
a black box memory for storing node data;
at least one packet preprocessor for selecting and processing a data packet required to be stored in a black box from node data transferred via a wired/wireless transmission medium;
a data storage for storing the node data transferred through the packet preprocessor in the black box memory;
a data reader for reading corresponding node data in response to a node data transfer request from an external device; and
a data transmitter for processing the node data read by the data reader in the form of a packet and transferring the packet to the external device.

2. The router of claim 1, further comprising:
a data filter for filtering only node data satisfying a configurable condition among the node data transferred through the packet preprocessor, and transferring the filtered node data to the data storage.

3. The router of claim 2, wherein each packet preprocessor is a line interface card including a line connection module, a unit for processing a physical layer of a packet, a processing unit for performing a series of processes, such as packet separation, authentication and scheduling, and a memory.

4. The router of claim 1, further comprising:
a data backup unit for backing up the node data stored in the black box memory to at least one designated router existing in the same network.

5. The router of claim 4, further comprising:
a data filter for filtering only node data satisfying a configurable condition among the node data transferred through the packet preprocessor, and transferring the filtered node data to the data storage.

6. The router of claim 5, wherein each packet preprocessor is a line interface card including a line connection module, a unit for processing a physical layer of a packet, a processing unit for performing a series of processes, such as packet separation, authentication and scheduling, and a memory.

7. The router of claim 4, wherein the black box memory comprises at least one memory means among a non-volatile circular buffer, a non-volatile flash memory, a hard disk, a compact flash memory, a Secure Digital (SD) card memory, a volatile Synchronous Dynamic (SD) Random Access Memory (RAM), a Static RAM (SRAM), a Rambus Dynamic RAM (RDRAM) and a Reduced Latency DRAM (RLDRAM).

8. The router of claim 1, wherein the black box memory comprises at least one memory means among a non-volatile circular buffer, a non-volatile flash memory, a hard disk, a compact flash memory, a Secure Digital (SD) card memory, a volatile Synchronous Dynamic (SD) Random Access Memory (RAM), a Static RAM (SRAM), a Rambus Dynamic RAM (RDRAM) and a Reduced Latency DRAM (RLDRAM).

9. The router of claim 8, wherein the data storage stores one piece of the node data in the at least one memory means in a required form.

10. A router having a black box function, comprising:
a black box memory for storing node data;
at least one line interface card for preprocessing and transferring a packet transferred via a wired/wireless transmission medium; and
a main processing unit for selectively storing node data transferred from each line interface card in the black box memory, and reading and transferring data requested to be transferred by an external device.

11. The router of claim 10, wherein the main processing unit backs up the node data stored in the black box memory to at least one designated router existing in the same network.

12. The router of claim 10, wherein the main processing unit or a processor of the line interface card filters only node data satisfying a configurable condition and stores the filtered node data in the black box memory.

13. The router of claim 10, wherein the black box memory comprises at least one memory means among a non-volatile circular buffer, a non-volatile flash memory, a hard disk, a compact flash memory, a Secure Digital (SD) card memory, a volatile Synchronous Dynamic (SD) Random Access Memory (RAM), a Static RAM (SRAM), a Rambus Dynamic RAM (RDRAM) and a Reduced Latency DRAM (RLDRAM).

14. A network system for relaying node data transferred from at least one node group via a wired/wireless transmission medium to a final destination device, the network system comprising:
a black box router for selecting a data packet required to be stored in a black box from the node data transferred via the transmission medium, storing the selected data packet in a black box memory, and reading and transferring data required by the final destination device among the stored data; and
an output router for transferring the data relayed or provided through the black box router to the final destination device.

15. The network system of claim 14, further comprising:
a backup device for backing up the node data stored in the black box router.

16. A network system, comprising:
a node for transferring a packet having information of a header including a first destination address and a second destination address;
a first router for transferring the packet to a device having the first destination address included in the header of the packet transferred from the node; and
a black box router for storing node data of the packet transferred from the first router in a black box memory, and relaying a corresponding node data packet to a device having the second destination address.

17. The network system of claim 16, further comprising:
a backup device for backing up the node data packet stored in the black box memory.
